(19) United States
(12) Patent Application Publication
(10) Pub. No.: US 2006/0051630 A1
(43) Pub. Date: Mar. 9, 2006

(54) Ultrasonics applied to electrochemical devices

(76) Inventors: Donald James Highgate, Surrey (GB); Simon Bourne, Sheffield (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/213,554

(22) Filed: Aug. 26, 2005

(30) Foreign Application Priority Data
Aug. 28, 2004 (GB) 0419255.5

(51) Int. Cl. H01M 8/00

(52) U.S. Cl. 429/13

(57) ABSTRACT

According to the invention, an electrochemical device is used In the presence of ultrasonic waves to improve the performance of the device. The ultrasound improves the performance of the electrochemical device.

### FIELD OF THE INVENTION

This invention relates to the use of ultrasound to improve the performance of electrochemical devices including but not limited to fuel cells and electrolysers

### BACKGROUND OF THE INVENTION

Electrochemical devices utilise selectively conductive media that allow the transmission of ions but not electrons. This selectively conductive medium may be a liquid electrolyte or an ionically conductive polymer.

Performance of such devices depends on many factors, principally:

1. The conductivity of the conductive medium,

2. The efficiency of the catalyst;

3. Mass transport of the reactants to, and products away from the “active area”, e.g. the interface between the catalyst the conducting medium and any electrode structure; and

4. Fuel/electron crossover.

Other factors, such as the temperature of the device, influence performance indirectly by impacting on the factors above.

The choice of solid polymer electrolyte (SPE) and catalyst are crucial to the performance of a fuel cell and electrolyser. The SPE is selected to have high ionic conductivity, low electronic conductivity and fuel cross-over. The catalyst is selected for high fuel oxidation activity and is attached to the SPE in a way that achieves a sound contact while permitting fuel access to the active area.

With the optimisation of the SPE and catalyst, this leaves mass transport as the single most Important performance limiter. Significant balance of plant and costly procedures are implemented in attempts to aid mass transport Knock on effects include the method of catalyst introduction to the SPE; expensive and elaborate techniques being utilised to try and improve mass transport to the active layer. Such techniques are invariably not suited to volume production.

Current methods employed to improve mass transport at the electrode/catalyst/SPE interfaces include:

1. Increasing the fuel and/or oxidant pressure (more fuel per unit volume);

2. Increasing fuel and/or oxidant flow rates (pass more fuel over the active area per unit time);

3. Use of complex flow fields to turbulate fuel and/or oxidant and maximise access to active area, and

4. Increase cell temperature to raise fuel and/or oxidant motion on a molecular level.

All of the above are inconvenient and expensive. Increasing the pressure requires additional balance of plant and necessitates more robust devices. Increasing flow rates necessitates larger fuel/oxidant storage capacity, and/or recirculation plumbing. Flow fields are typically milled into graphite manifolds/bipolar plates, these are complex components, the production of which is expensive. Elevating the temperature of the device also requires additional balance of plant and precludes utilisation in some applications.

### SUMMARY OF THE INVENTION

The invention utilises an ultrasonic device to produce ultrasonic waves as continuous waves or pulses to improve the performance of an electrochemical device.

According to a first aspect of the invention, a method for improving the performance of an electrochemical device comprises applying ultrasound to the device.

The method may be carried out on any electrochemical device, including a fuel cell or stack or an electrolyser cell or stack Alternatively, the electrochemical device may be a photovoltaic cell.

According to a second aspect of the invention, ultrasound is used as a means of circulating a fuel and/or oxidant in a fuel cell or stack.

According to a third aspect of the invention, ultrasound is used as a means of circulating water through an electrolyser cell or stack.

According to a fourth aspect of the invention, ultrasound is used to aid the removal of product gas from an electrolyser cell or stack.

According to a fifth aspect of the invention, ultrasound is used to produce and control the frequency of an AC component in the voltage output of a fuel cell.

According to a sixth aspect of the invention, ultrasound is used to aid the conversion of a DC fuel cell output to an AC signal.

### DESCRIPTION OF THE DRAWINGS

FIG. 1 is a graphic representation of an electrochemical device brought into contact with ultrasonic waves; and

FIG. 2 is a graphic representation of an electrochemical device brought into contact with ultrasonic waves, where the direction of ultrasound is perpendicular to a membrane contained in the electrochemical device.

### DETAILED DESCRIPTION OF THE INVENTION

The invention may be carried out using conventional electrochemical devices and conventional ultrasonic devices.

Electrochemical cells, and in particular fuel cells, may be in the form of a membrane electrode assembly (MEA). Solid polymer electrolyte fuel cell MEAs typically have a multi-layered structure comprising (i) a Proton Exchange Membrane (PEM), (ii) a current-collecting electrode, and (iii) an electro-catalyst layer an each side. A PEM operates by virtue of containing embedded cationic sites, allowing the transmission of anions. Equally, a solid polymer electrolyte may contain fixed anionic sites, and which is capable of preferentially transmitting cations. References to PEM below are thus not exclusive.

A structure as described above is assembled from discrete elements and bonded Into an MEA by the use of heat and pressure, before being assembled between gas manifolds, the whole structure being sealed against gas leakage (and crossover) to form a single cell.

PEM devices operate by virtue only of the properties built into the membrane. In use as an electrolyser, the addition of water and electricity yields oxygen and hydrogen; In use as a fuel cell, hydrogen and oxygen (or air) are used, and electricity results.

Existing PEM materials, e.g. Nafion, consist of a non-cross-linked fluorinated polymer (essentially PTFE) with pendent side-chains containing an ionically active site (normally SO₃). Hydrophilicity is provided by the SO₃ sites. These materials must be kept hydrated with additional water (supplied via hydrated fuel gas) to operate. They are available as thin sheets, 10-30 μm thick, for assembly into cells (voltage 1 V) and thus into cell stacks (typically 100 units). A stack may be produced from individual MEAs.

Hydrophilic polymers, capable of having a high water content, are known. The level of water content determines their properties. Their electrical properties are defined by the properties of the hydrating solution. For example, certain hydrophilic materials such as HEMA (2-hydroxyethyl methacrylate) and MMA-VP (methyl ethacrylate-vinylpyrrolidone) are well known in the biomedical field as contact lens materials, but they possess no intrinsic electrical properties.

In a preferred embodiment, ion-exchange membrane (IEM) materials, in particular PEM materials (but including cationic materials, as described above), can be produced based upon hydrophilic polymers (i.e. polymers inherently able to absorb and transmit water throughout their molecular structure). Such materials, modified to include sulphonic acid or other strongly ionic moieties, can be made by bulk polymerisation from an initial monomer or prepolymer system by radiation or thermal polymerisation. Polymerisation should be conducted In the presence of water and additionally also another liquid such that the system is homogeneous.

The ability to produce IEM materials, by polymerisation in situ, allows a one-step route for the production of stacks. Further, It is possible to produce a composite polymer-electrode system In which a polymer separator interpenetrates and extends the active surface area of the electrode or electrode catalyst system. This system is disclosed in GB2380055, the content of which is incorporated herein by reference.

The ultrasonic device may be any device capable of producing ultrasound. The device is typically operated by attaching the device so that ultrasound is produced in the water source in which the electrochemical device is placed. The introduction of ultrasound improves the performance by increasing the turbulation of the fuel and/or oxidant at the active catalyst sites. The introduction of ultrasound may also improve performance by locally increasing fuel and/or oxidant pressure at the active catalyst site. Ultrasound may also improve the performance by locally increasing the temperature of the solid polymer electrolyte due to friction. Cavitation caused by ultrasound may also Improve the performance by locally increasing the temperature of the fuel and/or the oxidant. Further, the introduction of ultrasound may improve the performance by causing the solid polymer electrolyte to flex, improving mass transport to active catalyst sites. When the electrochemical device is a fuel cell, the addition of alcohol to the fuel cell encourages cavitation and subsequent heating and/or mass transfer, due to the introduction of ultrasound, improving the performance of the fuel cell. In the context of an electrolyser, the addition of alcohol to the water feed encourages cavitation and subsequent heating and/or mass transfer, due to the application of ultrasound.

When the electrochemical device is a fuel cell, the fuel cell may be fed with gaseous fuel and gaseous oxidant Alternatively, the fuel cell may be fed with liquid fuel and a gaseous oxidant. Alternatively, the fuel cell may be fed with a gaseous fuel and a liquid oxidant. Alternatively, the fuel cell may be fed with liquid fuel and liquid oxidant. Suitable fuels include hydrogen, a solution containing alcohol, a solution containing sodium borohydride, a solution containing an alkaline moiety, or a solution containing an acidic moiety. Suitable oxidants include pure oxygen, air, a solution containing potassium permanganate.

Ultrasound may be applied to the electrochemical device at a constant frequency or may be pulsed. Alternatively, the ultrasound frequency may be swept from a low frequency to a high frequency or from a high frequency to a low frequency.

In a preferred embodiment, the electrochemical device contains a solid polymer electrolyte, which is preferably intrinsically acidic or intrinsically alkaline.

The following descriptions involving fuel cells are for the purpose of example only and should not be taken to limit the application of the general principle described.

### EXAMPLE 1

### Methanol Based Fuel, Alkaline SPE

A test cell was made with an active area 30 mm diameter. The Membrane Electrode Assembly (MEA) was made using a hydrophilic alkaline based polymer membrane, as disclosed in GB2380055, and pressing on PtRu catalyst coated carbon cloth (Nafion treated) at the anode and Pt Black coated carbon cloth (Nafion treated) at the cathode. The test cell was submerged in a water bath, at 25° C. The anode chamber was fed with a fuel solution containing 2M methanol and, 2M NaOH. The cathode chamber was fed with oxygen as oxidant.

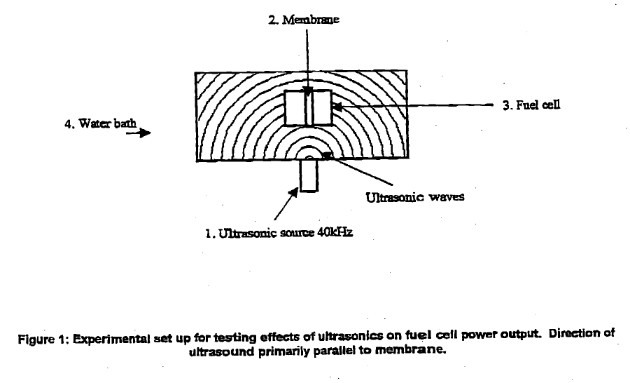

Ultrasound was introduced to the test cell by attaching the ultrasonic source to the base of the water bath. The presence of water enabled efficient transfer of ultrasound into the test cell. The direction of ultrasound was primarily parallel to the SPE membrane as shown in FIG. 1.

The effect of the ultrasound (40 kHz) was measured by conducting polarisation tests with the ultrasonic device off and then on.

On activation of the ultrasound, the peak power output of the cell increased by 54%.

### EXAMPLE 2

### Sodium Borohydride Based Fuel, Acidic SPE

An alternative experiment conducted using an acidic hydrophilic polymer membrane utilising the same test cell. This time the platinum catalyst was sued on both the anode and cathode. The anode was fed with a fuel solution containing sodium borohydride and potassium hydroxide, the cathode was fed with oxygen. The cell was positioned as shown in FIG. 1. Upon activation of the ultrasound, the power output from the cell Increased by 42.9%.

### EXAMPLE 3

### Alternative Angle of Ultrasound Introduction

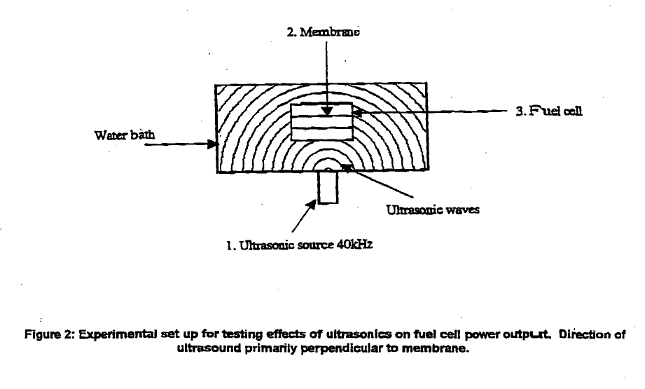

The cell used in Example 2 above was repositioned in the water bath by rotating it through 90° so the anode chamber was perpendicular to the ultrasound source as shown in FIG. 2. Upon activation of the ultrasound, the power output from the cell increased by 50%.

### EXAMPLE 4

### Alternating Output Voltage Component

Fuel cells are d-c devices, on application of ultrasound, fluctuations of the d-c output voltage were observed which were in phase with the Input ultrasound signal and of an amplitude which depended upon the magnitude of the input ultrasound signal.

1. A method for improving the performance of an electrochemical device comprising applying ultrasound to the device.

2. The method according the claim 1, wherein the electrochemical device is a fuel cell or stack.

3. The method according to claim 1, wherein the electrochemical device is an electrolyser cell or stack.

4. The method according to claim 1, wherein the electrochemical device is a photo voltaic cell.

5. A method for:
a) circulating fuel and/or oxidant in a fuel cell or stack;
b) circulating water through an electrolyser cell or stack;
c) removing product gas from an electrolyser cell or stack;
d) producing and controlling the frequency of an ac component in the voltage output of a fuel cell; or
e) aiding the conversion of DC cell output to an AC signal;
wherein said method comprises the use of ultrasound.

6. The method according to claim 5, wherein ultrasound is used as a means of circulating fuel and/or oxidant in a fuel cell or stack.

7. The method according to claim 5, wherein ultrasound is used as a means of circulating water through an electrolyser cell or stack.

8. The method according to claim 5, wherein ultrasound is used to aid the removal of product gas from an electrolyser cell or stack.

9. The method according to claim 5, wherein ultrasound is used to produce and control the frequency of an AC component in the voltage output of a fuel cell.

10. The method according to claim 5, wherein ultrasound is used to aid the conversion of a DC cell output to an AC signal.
